(19) United States
(12) Patent Application Publication
(10) Pub. No.: US 2026/0170003 A1
(43) Pub. Date: Jun. 18, 2026

(54) EXPLANATION GENERATION APPLICATION PROGRAMMING INTERFACE FOR DATA MODELS WITH CORE DATA SERVICES EXPLAIN

(71) Applicant: SAP SE, Walldorf (DE)

(72) Inventors: Fabian Fellhauer, Östringen (DE); Boyan Boychev, Karlsruhe (DE); Immo-Gert Birn, Philippsburg (DE); Matthias Herchenroether, Heidelberg (DE); Fee Grauf, Spechback (DE); Kolja Gross, Karlsruhe (DE); Katharina Altrichter, Heidelberg (DE); Felipe Velloso Alves, Rauenberg (DE); Santiago Zuniga Garcia, Mannheim (DE)

(21) Appl. No.: 18/978,931

(22) Filed: Dec. 12, 2024

(51) Int. Cl. G06F 16/25; G06F 16/21

(52) U.S. Cl. CPC G06F 16/254; G06F 8/10; G06F 16/212

(57) ABSTRACT

A core data services (CDS) explain agent receives a CDS explain request to generate an explanation with respect to a CDS data model. A CDS explain process is orchestrated for the CDS data model using a CDS explain handler of the CDS explain agent. A validator of the CDS explain agent and advanced business application programming (ABAP) dictionary metadata is used to validate if a CDS entity exists and if the CDS entity can be explained. Using a prompt assembler of the CDS explain agent, a large language model (LLM) prompt is assembled by combining multiple prompt snippets that satisfy the explanation with respect to a CDS data model. Using a CDS explain request processor of the CDS explain agent, the LLM prompt is transmitted to an LLM. Using a post-processor of the CDS explain agent, relevant information of a response from the LLM is extracted.

### BACKGROUND

All software applications (or “applications”) are based on data models, which define attributes, relationships, and data access strategies for semantics (e.g., business partners, orders, and invoices). With SAP, most of the data models are built with core data services (CDS), an infrastructure used by application developers to create an underlying data model for application services. CDS hides complexity of database specifics. It is part of the SAP Advanced Business Application Programming (ABAP) model and provides a means to declaratively capture service definitions and data models. CDS is integrated into SAPs ABAP programming language and offers features such as leveraging data dictionary semantics, consistent lifecycle management, and extensibility. Data models built with CDS include multiple objects, such as CDS views, CDS entities, database tables, CDS tuning objects, or other artifacts.

Currently, the artifacts need to be documented manually by user assistant (UA) developers. As a result, the amount of created development objects versus UA developer workload is not balanced, resulting in a small amount (e.g., 5%) of production data models being documented (which is not helpful to receiving users), users find it difficult to find a proper data model for building extensions in explorer applications, quality of documentation of third-party content cannot be ensured, and a large number of UA developers need to be used due to a large number of developed data objects.

### SUMMARY

The present disclosure describes providing an explanation generation application programming interface for data models with core data services explain.

In an implementation, a computer-implemented method, comprises: receiving, by a core data services (CDS) explain agent, a CDS explain request to generate an explanation with respect to a CDS data model; orchestrating, for the CDS data model and using a CDS explain handler of the CDS explain agent, a CDS explain process; validating, using a validator of the CDS explain agent and advanced business application programming (ABAP) dictionary metadata, if a CDS entity exists and if the CDS entity can be explained; assembling, using a prompt assembler of the CDS explain agent, a large language model (LLM) prompt by combining multiple prompt snippets that satisfy the explanation with respect to a CDS data model; transmitting, using a CDS explain request processor of the CDS explain agent, the LLM prompt to an LLM; and extracting, using a post-processor of the CDS explain agent, relevant information of a response from the LLM.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, prior to the availability of an application programming interface (API) associated with the described approach, only some structured metadata could be exported from a software system, which had been manually documented. With the described approach, creation of documentation can be fully automated end-to-end, resulting in high-efficiency and a drastic reduction of total costs of development (TCD). Second, with the general availability of large language models (LLMs), it is now easily possible to generate descriptive text. Based on natural language technology, it is also possible to design an API, which generates textual explanations based on given metadata of data models. The described approach is focused on metadata extraction, prompt engineering, and response handling of the LLMs to ensure a qualitatively good result based on available data models. Third, the API of the described approach permits at least the following use cases to be addressed: 1) documentation for data models can directly be generated without involvement of a user assistant (UA) developer (more objects can be automatically documented and there is less workload for the UA developers); 2) applications and development tools can provide explanations of undocumented data models on request by directly invoking an explanation API. This results in a consistent picture of content even if created by different parties; 3) explorer applications benefit from an increasing number of documented data models, as it becomes easier to search the generated data model documentation; and 4) due to the automatic generation of documentation text, it is possible to automatically update the documentation text whenever something is changed in the data model, so that documentation is not out-of-date.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram of a system and process for providing an explanation generation application programming interface for data models with core data services explain, according to an implementation of the present disclosure.

FIG. 2 is a screenshot of an example of selecting a core data services (CDS) source file (Data Definition Language Source (DDLS)), according to implementations of the present disclosure.

FIG. 3 is a screenshot of an example of opening a context menu on the screenshot of FIG. 2 and choosing CDS Explain in an artificial intelligence (AI) chat window (Joule), according to implementations of the present disclosure.

FIG. 4 is a screenshot of an example CDS Explain result on the screenshot of FIG. 2, according to implementations of the present disclosure.

FIG. 5 is a flowchart illustrating an example of a computer-implemented method for providing an explanation generation application programming interface for data models with core data services explain, according to an implementation of the present disclosure.

FIG. 6 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes providing an explanation generation application programming interface for data models with core data services explain and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

All software applications (or “applications”) are based on data models, which define attributes, relationships, and data access strategies for semantics (e.g., business partners, orders, and invoices). With SAP, most of the data models are built with core data services (CDS), an infrastructure used by database developers to create an underlying data model for application services. It is part of the SAP Advanced Business Application Programming (ABAP) model and provides a means to declaratively capture service definitions and data models. CDS is integrated into SAPs ABAP programming language and offers features such as leveraging data dictionary semantics, consistent lifecycle management, and extensibility. Data models built with CDS include multiple objects, such as CDS views, CDS entities, database tables, CDS tuning objects, or other artifacts.

Currently, the artifacts need to be documented manually by user assistant (UA) developers. As a result, the amount of created development objects versus UA developer workload is not balanced, resulting in a small amount (e.g., 5%) of production data models being documented (which is not helpful to receiving users), users find it difficult to find a proper data model for building extensions in explorer applications, quality of documentation of third-party content cannot be ensured, and a large number of UA developers need to be used due to a large number of developed data objects.

At a high-level, a described approach provides a feature called CDS explain, which is a semantic explanation of CDS-based data models. CDS-based data models might be very complex, due to a high number of elements, such as fields and associations to other entities. It is not always clear for an application developer, which CDS entity is suitable for which use case. The described approach leverages generative artificial intelligence (AI) (genAI)-based capabilities to provide explanations for the CDS-based data models.

CDS explain provides an explanation application programming interface (API) to permit fully automated end-to-end creation of documentation for data models, resulting in high-efficiency and a drastic reduction of total costs of development (TCD). This is in contrast to current manual documentation of structured metadata which can be exported from a software system. With the general availability of large language models (LLMs), it is now easily possible to generate text. Based on natural language technology, it is also possible to design the previously mentioned API, which can generate textual explanations based on given metadata of data models. The described approach is focused on metadata extraction, prompt engineering, and response handling of the LLMs to ensure a qualitatively good result based on available data models.

The described approach permits an application developer to simply retrieve a short explanation of the CDS view associated with a data model, which helps in understanding the CDS data model. The explanation is generated in an automated manner. UA developers benefit by a reduction of their workload in documentation, permitting focus on more substantive development efforts.

The explanation API of the described approach permits at least the following use cases to be addressed: 1) documentation for data models can directly be generated without involvement of a user assistant (UA) developer (i.e., more objects can be automatically documented and there is less workload for the UA developers); 2) applications and development tools can provide explanations of undocumented data models on request by directly invoking the explanation API. This results in a consistent picture of content even if created by different parties; and 3) explorer applications benefit from an increasing number of documented data models, as it becomes easier to search the generated data model documentation.

With respect to the use of LLMs, commonly available LLMs excel at summarizing large amounts of text. However, these LLMs lack understanding of syntax, meaning, and rules associated with SAP data and proprietary languages such as ABAP CDS. This is addressed in the described approach.

Depending on input and output of a LLM, response times may drastically vary and exceed expectations of developers and end users. The described approach addresses this issue to maintain performance expectations for generating explanations of CDS data models.

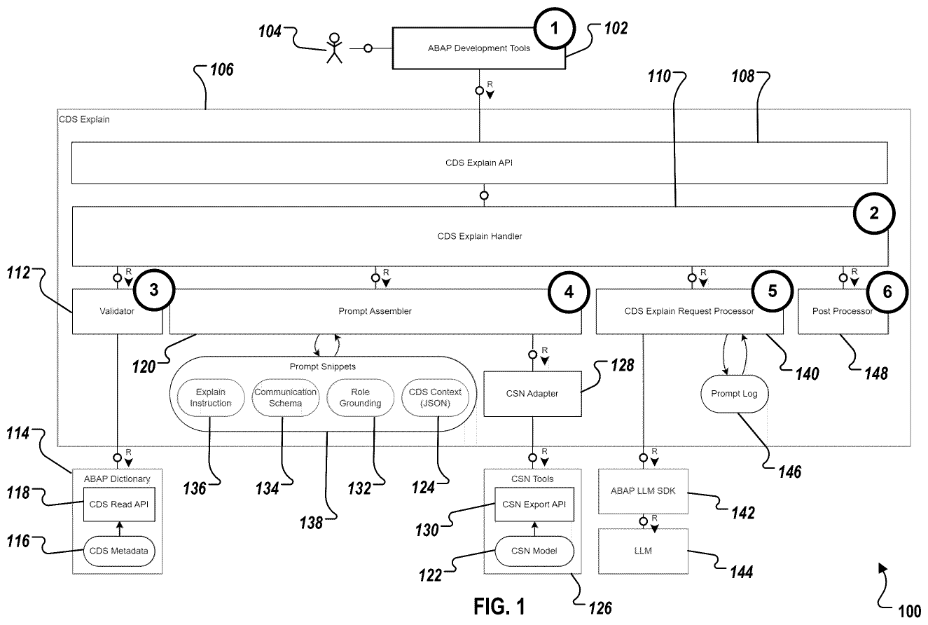

FIG. 1 is a block diagram of a system and process for providing an explanation generation API for data models with CDS explain, according to an implementation of the present disclosure.

### Agent Description.

ABAP Development Tools (ADT) 102 is the primary tool for users 104 working with CDS data models. Here, in an implementation, action for the CDS explain 106 is integrated into a chat window, called Joule. The request is then sent to an ABAP backend/server (i.e., all components except ADT 102) containing the CDS explain logic (i.e., CDS Explain 106).

A CDS Explain API 108 is an API facade for client consumption and used to communicate between the ADT 102 and a CDS Explain Handler 110.

The CDS Explain Handler 110 is used to orchestrate an overall explain process for a given data model and to redirect a request along different sub handlers (e.g., see sequence (3)-(6) that follows).

A Validator 112 is used to validate in accordance with the ABAP Dictionary 114 metadata (CDS Metadata 116), if a given CDS entity exists and if it can be explained. The Validator 112 uses the CDS Read API 118 to access the CDS Metadata 116 in the ABAP Dictionary 114. In some implementations, the Validator 112 can cross-check user input prior to assembly of a large language model (LLM) prompt.

A Prompt Assembler 120 triggers, on the fly, a JavaScript Object Notation (JSON)-based metadata export of a CDS data model 122 (called Core Schema Notation (CSN)) or CSN Model 122, which is then stored as CDS Context 124 (a JSON object) for prompting. The Prompt Assembler 120 accesses CSN Tools 126 through a CSN Adapter 128 using a CSN Export API 130 to access the CSN Model 122.

The CSN export API 130 accesses the CSN model 122 (a pre-compiled JSON object). In some implementation, the pre-compiled JSON object is created by lazy loading, whenever it is needed, but cached inside an ABAP server. The generation is based on the ABAP Dictionary Metadata of a CDS entity (i.e., CDS Metadata 116). The pre-compiled JSON object contains information about the name of the CDS entity, attributes, descriptions, type information, associations, and other data consistent with this disclosure.

In some implementations, the Prompt Assembler 120 assembles an LLM prompt by combining Role Grounding 132, Communication Schema 134, Explain Instruction 136, and the CDS Context (JSON) 124 accessed through a Prompt Snippets 138 data store. The Explain Instruction 136 is a hard coded snippet in source code. Communication Schema 134 is a JSON file stored in the backend. Role Grounding 132 is hard coded in source code. CDS Context (JSON) 124 is a JSON file created by the CSN Export API 130.

A CDS Explain Request Processor 140 executes a request and sends a prompt to an ABAP LLM software development kit (SDK) 142, which handles hypertext transfer protocol (HTTP) handling for external LLM 144 communication. Further, the CDS Explain Request Processor 140 logs the request and result in a Prompt Log 146.

A Post Processor 148 is used to extract relevant information of the response, add additional information, which is already transparently present in the system, and perform formatting, depending on the user 104 request (e.g., markdown or hypertext markup language (HTML) formatting). In some implementations, relevant information includes relevant CDS metadata, descriptive texts, and object type descriptions. In some implementations, the Post-Processor 148 can be used to mitigate risk of LLM hallucinations and to improve formatting of the response from the LLM (e.g., based on a format chosen in the Communication Schema 134).

Following post-processing, a result can be displayed to a user making a CDS explain request. For example, the result can be displayed in the chat window where the request was made or in another window/dialog.

### Explain Scope.

Explain scope defines different sections/semantic chapters, which should be shown to the user 104, when a data model is explained. To ensure consistency across a large variety of different data models, aligned sections are required. Otherwise, each explain request would result in differently structured outputs on an LLM (e.g., LLM 144) side.

In some implementations, Table 1 provides an overview about different sections, which are currently explained in case of CDS entities:

TABLE 1

| Section | Benefit | Decision |
|---|---|---|
| Purpose | Explains a general purpose of | High in Scope |
| | a CDS entity. | |
| Business Questions | List some questions, which | High in Scope |
| | can be answered with the data | |
| | of the CDS entity. | |
| Sample Data Record | Generates a sample data | To be determined |
| | record to visualize potential | |
| | data. | |
| Fields | Explains the most important | To be determined |
| | fields of the CDS entity. | |

### Prompt Design.

The design of the prompt is crucial for the success of the project. In some implementations, for the CDS explain feature, the prompt is structured in four different sections: 1) Role Grounding; 2) Communication Schema; 3) CDS Context (JSON) of the explain data model; and 4) Explain Instruction. These sections are called prompt snippets (i.e., Prompt Snippets 138) and are required to build a meaningful prompt for an LLM. Further, in some implementations, each prompt snippet can be versioned, which can be useful in analysis tasks (such as, benchmarking overall results when prompt snippets are changed in prompts to determine if LLM results are more or less relevant, correct, etc.).

### General Framing of the LLM.

A general framing of the LLM (e.g., LLM 144)) is required to achieve an answer, which reads itself like official documentation. For example, how LLMs answer is usually very different. Some answers are more polite, others are more precise. It Is important to receive answers, which sound similar to “official documentation” and not part of a casual conversation. For that, an example prompt snippet can be:
You are an expert in ABAP CDS and technical writing. Do not use hate speech, offensive language, or any kind of discrimination. Answer in valid JSON only.
Always check that the response is valid JSON and correct the result if that is not the case.
--version ‘ABAPExpert v1.1.0’

### Instruction of the Required Response Format.

Handling natural language as a plain response format is very difficult later on, especially, if multiple information is returned by the LLM, which may be validated, formatted, or processed differently. Therefore, in some implementations, the LLM is instructed to always use JSON as a response format. As an example, the following JSON schema can be used for communication in CDS explain:

{
“metadata” : {
“version” : “JSON v1.2.2”,
“description” : “”,
“pathToEntityDescription” : “CDSEntityPurposeDescription”,
“pathToBusinessQuestions” : “BusinessQuestions”,
},
“body” : {
“type”: “object”,
“properties”: {
“CDSEntityName”: {
“type”: “string”,
“description”: “Name of CDS Entity”
},
“CDSEntityPurposeDescription”: {
“type”: “string”,
“description”: “Purpose of the CDS Entity (5 sentences)”
},
“BusinessQuestions” : {
“type” : “string”,
“description” : “5 business questions, which could be
answered by the data of the
CDS Entity. String
separated with bullet points.”
}
}
}
}.

In some implementations, the JSON schema file is divided in two different major sections:
1. Metadata: defines a current schema version and external interface of the JSON file, which is exposed in the CDS explain API 108. This needs to be kept stable/compatible.
2. Body: is used for communication with the LLM 144 and can be changed frequently (depending on a concrete LLM model and associated capability).

Defining a JSON schema as previously described has advantages for the framework development of CDS explain:
1. Communication body with the LLM 144 can be changed frequently, without disrupting the external interface of the CDS explain API 108. As a result, optimizations and benchmarking can easily be performed and prototyped, even without taking a complete validation pipeline into consideration.
2. Versioning and communication format is in one location. Changing the communication format without adapting the version leads to disruptions in the benchmarking later on.

### Context Information of the Data Model.

LLMs are typically not up to date regarding data stored in the model itself (e.g., GPT4 of OpenAI was cut off from adding additional data in 2021). Data models however continue to evolve. As a result, relevant information of the data model needs to be handed over to the LLM to generate a meaningful explanation. LLMs usually have two different ways of accessing knowledge. Either, information was trained, by providing a number of examples. However, if questions are asked for information, which was not trained, LLMs are going to extrapolate the data. By that, a potentially correct answer may occur, based on similar facts. However, for the described approach, this is not precise enough, as documentation always needs to be 100% accurate. Therefore, the described approach needs to hand over relevant context (in this case the CDS model) with the prompt, to ensure that correct metadata is accessed and correct documentation is generated.

In some implementations, for generating an explanation, the following metadata of a data model is deemed relevant:
1. Name and description of the CDS entity.
2. Attributes, their descriptions and data types with descriptions.
3. Associations and their targets with their descriptions.
4. Annotations.

Further, the following need to be considered:
1. LLMs do not properly understand ABAP CDS syntax (especially new keywords). Therefore, no CDS syntax is sent to the LLM. CDS syntax/metadata is converted into a JSON representation.
2. Not only the metadata of the CDS view itself is relevant, but also of the dependencies.
   a. Association targets.
   b. Data elements.
   c. CDS simple types.
   d. Data sources.

In the ABAP server, there is already a metadata representation of CDS entities, which fulfills those criteria: CSN model 122. The CSN export API 130 is used for bundling context information of the CDS explain. There is a reuse service in ABAP available to generate a JSON based representation of CDS.

### Prompted Action.

The prompt action instructs the LLM 144 to execute a specific task for the given context information. In some implementations, the following prompt can be used:
Describe the XYZ CDS Object <placeholder> semantically in valid JSON format.
--version ‘DESCRIBE v1.2.0’.

### Prompt Assembling.

Different Prompt Snippets 138 are assembled in sequential order and bundled in a request, which is handed over to the ABAP LLM SDK 142 for communication to the LLM 144.

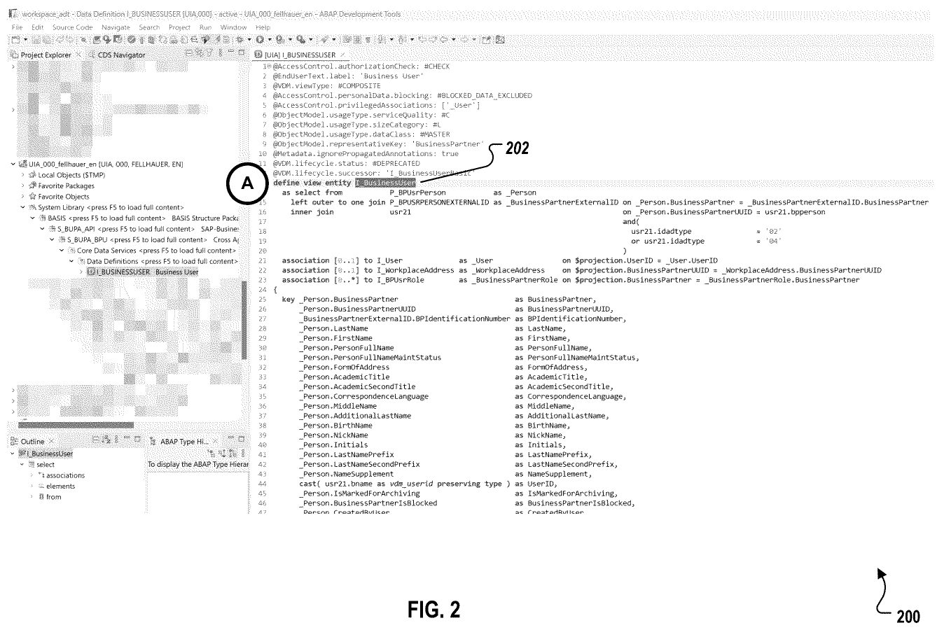

FIG. 2 is a screenshot 200 of an example of selecting a CDS source file (Data Definition Language Source (DDLS)), according to implementations of the present disclosure.

At (A), a CDS source file is opened. Here the CDS source file name is “I_BusinessUser” 202.

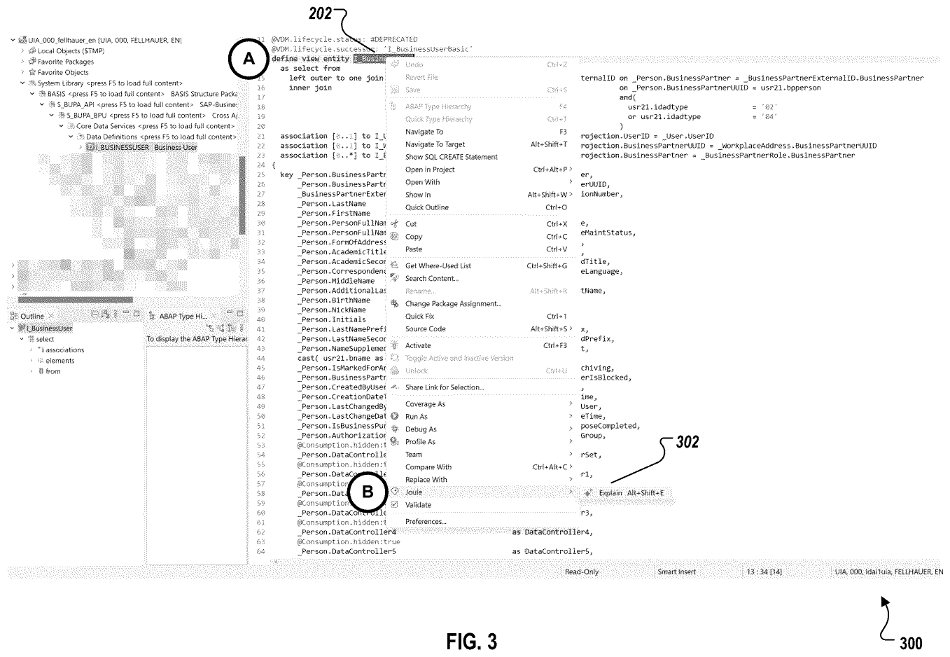

FIG. 3 is a screenshot of an example of opening a context menu on the screenshot 200 of FIG. 2 and choosing CDS Explain in an AI chat window (Joule), according to implementations of the present disclosure.

At (B), a context menu is opened and CDS Explain selected choose Joule->Explain 302.

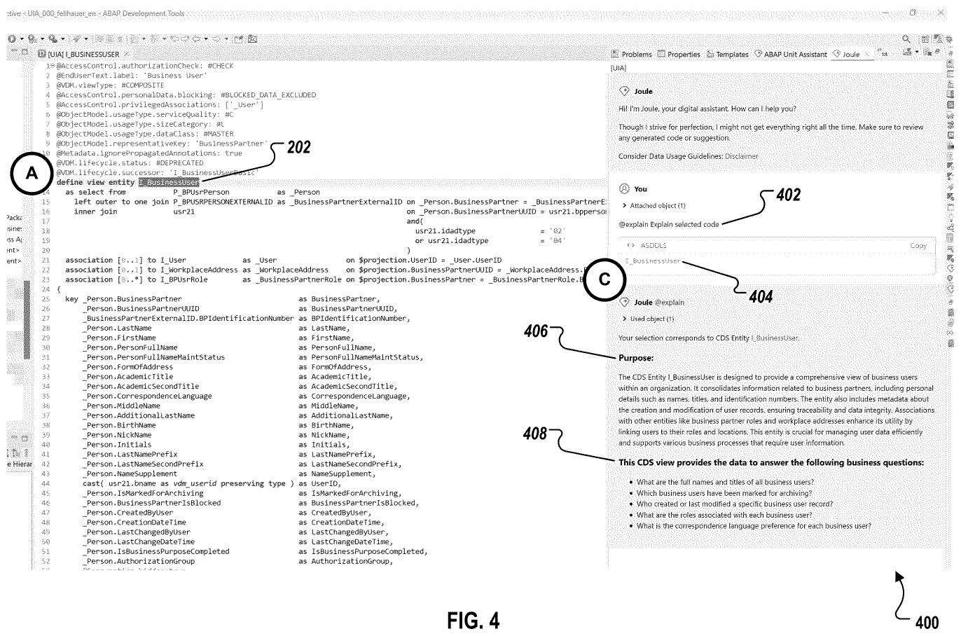

FIG. 4 is a screenshot 400 of an example CDS Explain result on the screenshot 200 of FIG. 2, according to implementations of the present disclosure. The CDS Explain result is shown at (C).

In some implementations, an identification of the Explain selected code 402 “I_BusinessUser” 404 is provided.

In some implementations, a Purpose 406 and data 408 that the CDS view provides to answer particular identified business questions is provided.

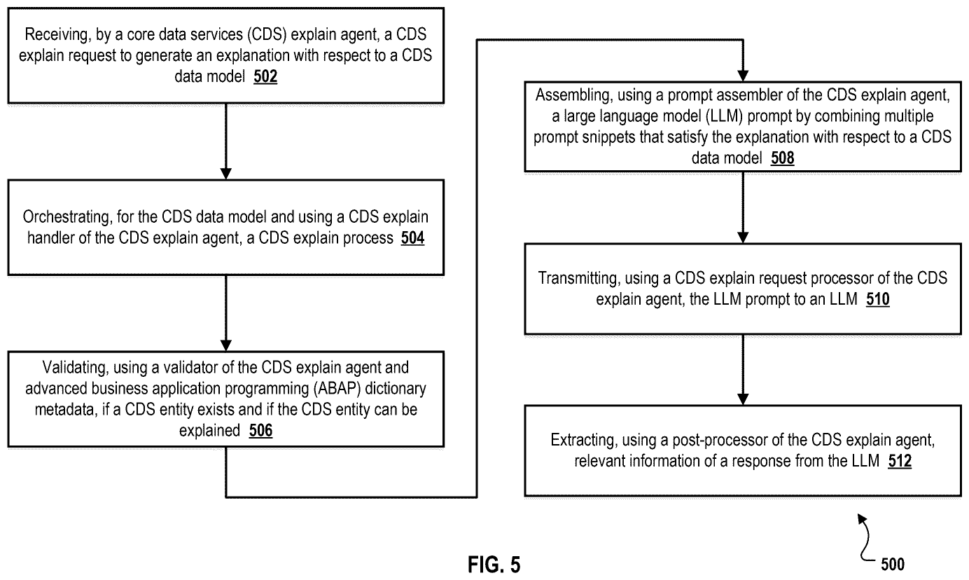

FIG. 5 is a flowchart illustrating an example of a computer-implemented method 500 for providing an explanation generation application programming interface for data models with core data services explain, according to an implementation of the present disclosure. For clarity of presentation, the description that follows generally describes method 500 in the context of the other figures in this description. However, it will be understood that method 500 can be performed, for example, by any system, environment, software, and hardware, or a combination of systems, environments, software, and hardware, as appropriate. In some implementations, various steps of method 500 can be run in parallel, in combination, in loops, or in any order.

At 502, a core data services (CDS) explain agent receives a CDS explain request to generate an explanation with respect to a CDS data model. In some implementations, the CDS explain request is generated by ABAP development tools (ADT) through use of a chat-type window. From 502, method 500 proceeds to 504.

At 504, a CDS explain process is orchestrated for the CDS data model using a CDS explain handler of the CDS explain agent. In some implementations, the CDS explain handler redirects the CDS explain request along different sub handlers. From 504, method 500 proceeds to 506.

At 506, a validator of the CDS explain agent and advanced business application programming (ABAP) dictionary metadata is used to validate if a CDS entity exists and if the CDS entity can be explained. From 506, method 500 proceeds to 508.

At 508, using a prompt assembler of the CDS explain agent, a large language model (LLM) prompt is assembled by combining multiple prompt snippets that satisfy the explanation with respect to a CDS data model. In some implementations, the multiple prompt snippets comprise explain instruction, communication schema, role grounding, and CDS context (JavaScript Object Notation (JSON)), which are access through a prompt snippets data store. In some implementations, the CDS context (JSON) is a JSON-based metadata export of the CDS data model. In some implementations, using the validator of the CDS explain agent, user input is cross-checked prior to assembly of the LLM prompt. From 508, method 500 proceeds to 510.

At 510, using a CDS explain request processor of the CDS explain agent, the LLM prompt is transmitted to an LLM. From 510, method 500 proceeds to 512.

At 512, using a post-processor of the CDS explain agent, relevant information of a response from the LLM is extracted. In some implementations, when extracting, using a post-processor of the CDS explain agent, relevant information of a response from the LLM, relevant information includes relevant CDS metadata, descriptive texts, and object type descriptions. In some implementations, the post-processor of the CDS explain agent is used to mitigate risk of LLM hallucinations and to improve formatting of the response from the LLM. After 512, method 500 can stop.

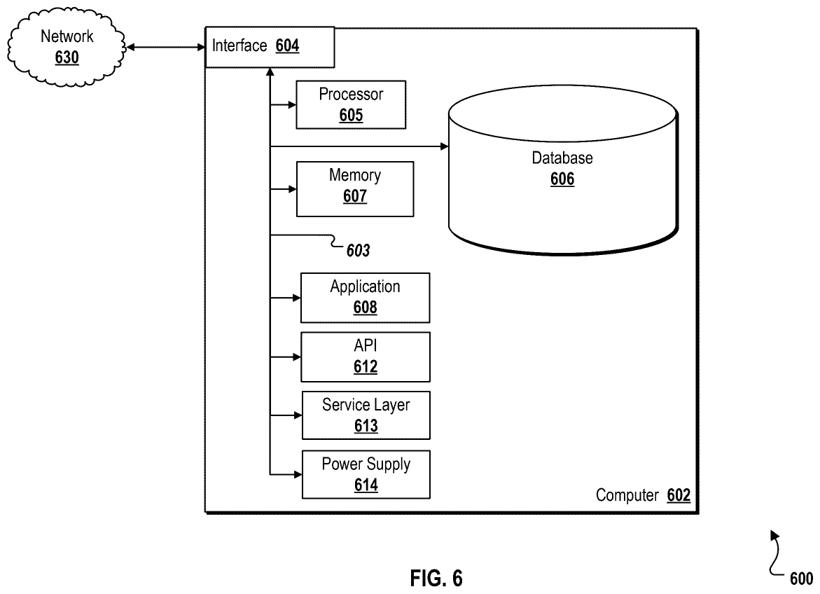

FIG. 6 is a block diagram illustrating an example of a computer-implemented System 600 used to provide computational functionalities associated with described algorithms, methods, functions, processes, flows, and procedures, according to an implementation of the present disclosure. In the illustrated implementation, computer-implemented system 600 includes a Computer 602 and a Network 630.

The illustrated Computer 602 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 602 can include an input device, such as a keypad, keyboard, or touch screen, or a combination of input devices that can accept user information, and an output device that conveys information associated with the operation of the Computer 602, including digital data, visual, audio, another type of information, or a combination of types of information, on a graphical-type user interface (UI) (or GUI) or other UI.

The Computer 602 can serve in a role in a distributed computing system as, for example, a client, network component, a server, or a database or another persistency, or a combination of roles for performing the subject matter described in the present disclosure. The illustrated Computer 602 is communicably coupled with a Network 630. In some implementations, one or more components of the Computer 602 can be configured to operate within an environment, or a combination of environments, including cloud-computing, local, or global.

At a high level, the Computer 602 is an electronic computing device operable to receive, transmit, process, store, or manage data and information associated with the described subject matter. According to some implementations, the Computer 602 can also include or be communicably coupled with a server, such as an application server, e-mail server, web server, caching server, or streaming data server, or a combination of servers.

The Computer 602 can receive requests over Network 630 (for example, from a client software application executing on another Computer 602) and respond to the received requests by processing the received requests using a software application or a combination of software applications. In addition, requests can also be sent to the Computer 602 from internal users (for example, from a command console or by another internal access method), external or third-parties, or other entities, individuals, systems, or computers.

Each of the components of the Computer 602 can communicate using a System Bus 603. In some implementations, any or all of the components of the Computer 602, including hardware, software, or a combination of hardware and software, can interface over the System Bus 603 using an application programming interface (API) 612, a Service Layer 613, or a combination of the API 612 and Service Layer 613. The API 612 can include specifications for routines, data structures, and object classes. The API 612 can be either computer-language independent or dependent and refer to a complete interface, a single function, or even a set of APIs. The Service Layer 613 provides software services to the Computer 602 or other components (whether illustrated or not) that are communicably coupled to the Computer 602. The functionality of the Computer 602 can be accessible for all service consumers using the Service Layer 613. Software services, such as those provided by the Service Layer 613, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 602, alternative implementations can illustrate the API 612 or the Service Layer 613 as stand-alone components in relation to other components of the Computer 602 or other components (whether illustrated or not) that are communicably coupled to the Computer 602. Moreover, any or all parts of the API 612 or the Service Layer 613 can be implemented as a child or a sub-module of another software module, enterprise application, or hardware module without departing from the scope of the present disclosure.

The Computer 602 includes an Interface 604. Although illustrated as a single Interface 604, two or more Interfaces 604 can be used according to particular needs, desires, or particular implementations of the Computer 602. The Interface 604 is used by the Computer 602 for communicating with another computing system (whether illustrated or not) that is communicatively linked to the Network 630 in a distributed environment. Generally, the Interface 604 is operable to communicate with the Network 630 and includes logic encoded in software, hardware, or a combination of software and hardware. More specifically, the Interface 604 can include software supporting one or more communication protocols associated with communications such that the Network 630 or hardware of Interface 604 is operable to communicate physical signals within and outside of the illustrated Computer 602.

The Computer 602 includes a Processor 605. Although illustrated as a single Processor 605, two or more Processors 605 can be used according to particular needs, desires, or particular implementations of the Computer 602. Generally, the Processor 605 executes instructions and manipulates data to perform the operations of the Computer 602 and any algorithms, methods, functions, processes, flows, and procedures as described in the present disclosure.

The Computer 602 also includes a Database 606 that can hold data for the Computer 602, another component communicatively linked to the Network 630 (whether illustrated or not), or a combination of the Computer 602 and another component. For example, Database 606 can be an in-memory or conventional database storing data consistent with the present disclosure. In some implementations, Database 606 can be a combination of two or more different database types (for example, a hybrid in-memory and conventional database) according to particular needs, desires, or particular implementations of the Computer 602 and the described functionality. Although illustrated as a single Database 606, two or more databases of similar or differing types can be used according to particular needs, desires, or particular implementations of the Computer 602 and the described functionality. While Database 606 is illustrated as an integral component of the Computer 602, in alternative implementations, Database 606 can be external to the Computer 602. The Database 606 can hold and operate on at least any data type mentioned or any data type consistent with this disclosure.

The Computer 602 also includes a Memory 607 that can hold data for the Computer 602, another component or components communicatively linked to the Network 630 (whether illustrated or not), or a combination of the Computer 602 and another component. Memory 607 can store any data consistent with the present disclosure. In some implementations, Memory 607 can be a combination of two or more different types of memory (for example, a combination of semiconductor and magnetic storage) according to particular needs, desires, or particular implementations of the Computer 602 and the described functionality. Although illustrated as a single Memory 607, two or more Memories 607 or similar or differing types can be used according to particular needs, desires, or particular implementations of the Computer 602 and the described functionality. While Memory 607 is illustrated as an integral component of the Computer 602, in alternative implementations, Memory 607 can be external to the Computer 602.

The Application 608 is an algorithmic software engine providing functionality according to particular needs, desires, or particular implementations of the Computer 602, particularly with respect to functionality described in the present disclosure. For example, Application 608 can serve as one or more components, modules, or applications. Further, although illustrated as a single Application 608, the Application 608 can be implemented as multiple Applications 608 on the Computer 602. In addition, although illustrated as integral to the Computer 602, in alternative implementations, the Application 608 can be external to the Computer 602.

The Computer 602 can also include a Power Supply 614. The Power Supply 614 can include a rechargeable or non-rechargeable battery that can be configured to be either user- or non-user-replaceable. In some implementations, the Power Supply 614 can include power-conversion or management circuits (including recharging, standby, or another power management functionality). In some implementations, the Power Supply 614 can include a power plug to allow the Computer 602 to be plugged into a wall socket or another power source to, for example, power the Computer 602 or recharge a rechargeable battery.

There can be any number of Computers 602 associated with, or external to, a computer system containing Computer 602, each Computer 602 communicating over Network 630. Further, the term “client,” “user,” or other appropriate terminology can be used interchangeably, as appropriate, without departing from the scope of the present disclosure. Moreover, the present disclosure contemplates that many users can use one Computer 602, or that one user can use multiple computers 602.

Described implementations of the subject matter can include one or more features, alone or in combination.

For example, in a first implementation, A computer-implemented method, comprising: receiving, by a core data services (CDS) explain agent, a CDS explain request to generate an explanation with respect to a CDS data model; orchestrating, for the CDS data model and using a CDS explain handler of the CDS explain agent, a CDS explain process; validating, using a validator of the CDS explain agent and advanced business application programming (ABAP) dictionary metadata, if a CDS entity exists and if the CDS entity can be explained; assembling, using a prompt assembler of the CDS explain agent, a large language model (LLM) prompt by combining multiple prompt snippets that satisfy the explanation with respect to a CDS data model; transmitting, using a CDS explain request processor of the CDS explain agent, the LLM prompt to an LLM; and extracting, using a post-processor of the CDS explain agent, relevant information of a response from the LLM.

The foregoing and other described implementations can each, optionally, include one or more of the following features:

A first feature, combinable with any of the following features, wherein the CDS explain request is generated by ABAP development tools (ADT) through use of a chat-type window.

A second feature, combinable with any of the previous or following features, wherein the CDS explain handler redirects the CDS explain request along different sub handlers.

A third feature, combinable with any of the previous or following features, wherein the multiple prompt snippets comprise explain instruction, communication schema, role grounding, and CDS context (JavaScript Object Notation (JSON)), which are access through a prompt snippets data store.

A fourth feature, combinable with any of the previous or following features, wherein the CDS context (JSON) is a JSON-based metadata export of the CDS data model.

A fifth feature, combinable with any of the previous or following features, wherein, when extracting, using a post-processor of the CDS explain agent, relevant information of a response from the LLM, relevant information includes relevant CDS metadata, descriptive texts, and object type descriptions.

A sixth feature, combinable with any of the previous or following features, comprising: cross-checking, using the validator of the CDS explain agent, user input prior to assembly of the LLM prompt; and using the post-processor of the CDS explain agent to mitigate risk of LLM hallucinations and to improve formatting of the response from the LLM.

In a second implementation, a non-transitory, computer-readable medium storing one or more instructions executable by a computer system to perform one or more operations, comprising: receiving, by a core data services (CDS) explain agent, a CDS explain request to generate an explanation with respect to a CDS data model; orchestrating, for the CDS data model and using a CDS explain handler of the CDS explain agent, a CDS explain process; validating, using a validator of the CDS explain agent and advanced business application programming (ABAP) dictionary metadata, if a CDS entity exists and if the CDS entity can be explained; assembling, using a prompt assembler of the CDS explain agent, a large language model (LLM) prompt by combining multiple prompt snippets that satisfy the explanation with respect to a CDS data model; transmitting, using a CDS explain request processor of the CDS explain agent, the LLM prompt to an LLM; and extracting, using a post-processor of the CDS explain agent, relevant information of a response from the LLM.

The foregoing and other described implementations can each, optionally, include one or more of the following features:

A first feature, combinable with any of the following features, wherein the CDS explain request is generated by ABAP development tools (ADT) through use of a chat-type window.

A second feature, combinable with any of the previous or following features, wherein the CDS explain handler redirects the CDS explain request along different sub handlers.

A third feature, combinable with any of the previous or following features, wherein the multiple prompt snippets comprise explain instruction, communication schema, role grounding, and CDS context (JavaScript Object Notation (JSON)), which are access through a prompt snippets data store.

A fourth feature, combinable with any of the previous or following features, wherein the CDS context (JSON) is a JSON-based metadata export of the CDS data model.

A fifth feature, combinable with any of the previous or following features, wherein, when extracting, using a post-processor of the CDS explain agent, relevant information of a response from the LLM, relevant information includes relevant CDS metadata, descriptive texts, and object type descriptions.

A sixth feature, combinable with any of the previous or following features, comprising: cross-checking, using the validator of the CDS explain agent, user input prior to assembly of the LLM prompt; and using the post-processor of the CDS explain agent to mitigate risk of LLM hallucinations and to improve formatting of the response from the LLM.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: receiving, by a core data services (CDS) explain agent, a CDS explain request to generate an explanation with respect to a CDS data model; orchestrating, for the CDS data model and using a CDS explain handler of the CDS explain agent, a CDS explain process; validating, using a validator of the CDS explain agent and advanced business application programming (ABAP) dictionary metadata, if a CDS entity exists and if the CDS entity can be explained; assembling, using a prompt assembler of the CDS explain agent, a large language model (LLM) prompt by combining multiple prompt snippets that satisfy the explanation with respect to a CDS data model; transmitting, using a CDS explain request processor of the CDS explain agent, the LLM prompt to an LLM; and extracting, using a post-processor of the CDS explain agent, relevant information of a response from the LLM.

The foregoing and other described implementations can each, optionally, include one or more of the following features:

A first feature, combinable with any of the following features, wherein the CDS explain request is generated by ABAP development tools (ADT) through use of a chat-type window.

A second feature, combinable with any of the previous or following features, wherein the CDS explain handler redirects the CDS explain request along different sub handlers.

A third feature, combinable with any of the previous or following features, wherein the multiple prompt snippets comprise explain instruction, communication schema, role grounding, and CDS context (JavaScript Object Notation (JSON)), which are access through a prompt snippets data store.

A fourth feature, combinable with any of the previous or following features, wherein the CDS context (JSON) is a JSON-based metadata export of the CDS data model.

A fifth feature, combinable with any of the previous or following features, wherein, when extracting, using a post-processor of the CDS explain agent, relevant information of a response from the LLM, relevant information includes relevant CDS metadata, descriptive texts, and object type descriptions.

A sixth feature, combinable with any of the previous or following features, comprising: cross-checking, using the validator of the CDS explain agent, user input prior to assembly of the LLM prompt; and using the post-processor of the CDS explain agent to mitigate risk of LLM hallucinations and to improve formatting of the response from the LLM.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
receiving, by a core data services (CDS) explain agent, a CDS explain request to generate an explanation with respect to a CDS data model;
orchestrating, for the CDS data model and using a CDS explain handler of the CDS explain agent, a CDS explain process;
validating, using a validator of the CDS explain agent and advanced business application programming (ABAP) dictionary metadata, if a CDS entity exists and if the CDS entity can be explained;
assembling, using a prompt assembler of the CDS explain agent, a large language model (LLM) prompt by combining multiple prompt snippets that satisfy the explanation with respect to a CDS data model;
transmitting, using a CDS explain request processor of the CDS explain agent, the LLM prompt to an LLM; and
extracting, using a post-processor of the CDS explain agent, relevant information of a response from the LLM.

2. The computer-implemented method of claim 1, wherein the CDS explain request is generated by ABAP development tools (ADT) through use of a chat-type window.

3. The computer-implemented method of claim 1, wherein the CDS explain handler redirects the CDS explain request along different sub handlers.

4. The computer-implemented method of claim 1, wherein the multiple prompt snippets comprise explain instruction, communication schema, role grounding, and CDS context (JavaScript Object Notation (JSON)), which are access through a prompt snippets data store.

5. The computer-implemented method of claim 4, wherein the CDS context (JSON) is a JSON-based metadata export of the CDS data model.

6. The computer-implemented method of claim 1, wherein, when extracting, using a post-processor of the CDS explain agent, relevant information of a response from the LLM, relevant information includes relevant CDS metadata, descriptive texts, and object type descriptions.

7. The computer-implemented method of claim 1, comprising:
cross-checking, using the validator of the CDS explain agent, user input prior to assembly of the LLM prompt; and
using the post-processor of the CDS explain agent to mitigate risk of LLM hallucinations and to improve formatting of the response from the LLM.

8. A non-transitory, computer-readable medium storing one or more instructions executable by a computer system to perform one or more operations, comprising:
receiving, by a core data services (CDS) explain agent, a CDS explain request to generate an explanation with respect to a CDS data model;
orchestrating, for the CDS data model and using a CDS explain handler of the CDS explain agent, a CDS explain process;
validating, using a validator of the CDS explain agent and advanced business application programming (ABAP) dictionary metadata, if a CDS entity exists and if the CDS entity can be explained;
assembling, using a prompt assembler of the CDS explain agent, a large language model (LLM) prompt by combining multiple prompt snippets that satisfy the explanation with respect to a CDS data model;
transmitting, using a CDS explain request processor of the CDS explain agent, the LLM prompt to an LLM; and
extracting, using a post-processor of the CDS explain agent, relevant information of a response from the LLM.

9. The non-transitory, computer-readable medium of claim 8, wherein the CDS explain request is generated by ABAP development tools (ADT) through use of a chat-type window.

10. The non-transitory, computer-readable medium of claim 8, wherein the CDS explain handler redirects the CDS explain request along different sub handlers.

11. The non-transitory, computer-readable medium of claim 8, wherein the multiple prompt snippets comprise explain instruction, communication schema, role grounding, and CDS context (JavaScript Object Notation (JSON)), which are access through a prompt snippets data store.

12. The non-transitory, computer-readable medium of claim 11, wherein the CDS context (JSON) is a JSON-based metadata export of the CDS data model.

13. The non-transitory, computer-readable medium of claim 8, wherein, when extracting, using a post-processor of the CDS explain agent, relevant information of a response from the LLM, relevant information includes relevant CDS metadata, descriptive texts, and object type descriptions.

14. The non-transitory, computer-readable medium of claim 8, comprising:
cross-checking, using the validator of the CDS explain agent, user input prior to assembly of the LLM prompt; and
using the post-processor of the CDS explain agent to mitigate risk of LLM hallucinations and to improve formatting of the response from the LLM.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
receiving, by a core data services (CDS) explain agent, a CDS explain request to generate an explanation with respect to a CDS data model;
orchestrating, for the CDS data model and using a CDS explain handler of the CDS explain agent, a CDS explain process;
validating, using a validator of the CDS explain agent and advanced business application programming (ABAP) dictionary metadata, if a CDS entity exists and if the CDS entity can be explained;
assembling, using a prompt assembler of the CDS explain agent, a large language model (LLM) prompt by combining multiple prompt snippets that satisfy the explanation with respect to a CDS data model;
transmitting, using a CDS explain request processor of the CDS explain agent, the LLM prompt to an LLM; and
extracting, using a post-processor of the CDS explain agent, relevant information of a response from the LLM.

16. The computer-implemented system of claim 15, wherein the CDS explain request is generated by ABAP development tools (ADT) through use of a chat-type window.

17. The computer-implemented system of claim 15, wherein the CDS explain handler redirects the CDS explain request along different sub handlers.

18. The computer-implemented system of claim 15, wherein the multiple prompt snippets comprise explain instruction, communication schema, role grounding, and CDS context (JavaScript Object Notation (JSON)), which are access through a prompt snippets data store.

19. The computer-implemented system of claim 18, wherein the CDS context (JSON) is a JSON-based metadata export of the CDS data model.

20. The computer-implemented system of claim 15, wherein, when extracting, using a post-processor of the CDS explain agent, relevant information of a response from the LLM, relevant information includes relevant CDS metadata, descriptive texts, and object type descriptions.
